(19) United States
(12) Patent Application Publication
(10) Pub. No.: US 2026/0350671 A1
(43) Pub. Date: Nov. 5, 2026

(54) Jurisdictional, Regulatory, and Platform-Level Compliance Filtering for Sealed Fulfillment

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/336,072

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.
(60) Provisional application No. 63/791,534, filed on Apr. 20, 2025.
(60) Provisional application No. 63/792,918, filed on Apr. 23, 2025.

(51) Int. Cl. G06Q 30/0601; G06Q 10/083

(52) U.S. Cl. CPC G06Q 30/0611; G06Q 10/083

(57) ABSTRACT

A platform-integrated compliance filtering system for sealed fulfillment. The invention blocks offers or transactions that fail jurisdictional, regulatory, platform-specific, or trust-based requirements. The system dynamically checks metadata and applies permission filters before execution can proceed. All non-compliant fulfillment attempts are denied and logged for enforcement.

### CROSS-REFERENCE TO RELATED APPLICATIONS

This application is a continuation of U.S. Utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates to jurisdictional and regulatory compliance in commercial fulfillment systems, and more specifically, to platform-native filters that enforce real-time compliance checks for sealed, trust-based transaction execution.

### BACKGROUND OF THE INVENTION

Most e-commerce and service platforms do not integrate jurisdictional filters at the execution level, allowing non-compliant offers to bypass regulatory and geographic constraints.

Global and regional regulations often differ in legality, licensing requirements, safety protocols, tax policy, and permissible transaction scope, yet current systems lack enforcement logic at the point of fulfillment.

There is a need for sealed platform rails that enforce layered compliance filters before any transaction may proceed, ensuring that offers meet legal and jurisdictional constraints dynamically.

### SUMMARY OF THE INVENTION

This invention introduces a compliance-enforced execution rail that filters all fulfillment attempts through jurisdictional, platform-specific, and regulatory requirements.

Each transaction is checked against a compliance matrix that includes geographic legality, industry regulation, licensing jurisdiction, trust threshold, tax validation, and platform-specific authorization.

The system prevents fulfillment if any requirement is not met, including vendor location mismatch, regulatory bans, trust-score violation, or missing licenses.

Vendors are required to pre-register with jurisdictional zones and platform categories to qualify for offer presentation.

The compliance layer is enforced at both the offer presentation and fulfillment stages, with real-time rejection of violations.

### BRIEF DESCRIPTION OF THE DRAWINGS

FIG. 1 Is a flow diagram illustrating the authentication and modular attachment process for embedded toolchains operating within licensed execution rails. Elements include [1501] toolchain request node, [1502] license verification module, [1503] platform authentication gate, and [1504] dynamic tool injection engine.

FIG. 2 Is a system diagram depicting the interoperability framework between embedded tools and platform-native trust services, including dynamic credential binding. Elements include embedded tool interface, [1511] trust service relay, [1512] credential binding logic, and platform execution container.

FIG. 3 Is a control layer diagram illustrating real-time enforcement of execution licensing for modular tools executing across sectors. Elements include [1520] execution monitoring layer, license validation engine, [1522] cross-sector compliance filter, and [1523] platform gating control.

FIG. 4 Is a logic flow diagram for license-restricted tool invocation, enabling system-level restriction of tool access to only those authorized within the execution environment. Elements include [1530] tool invocation port, [1531] license boundary validator, [1532] platform permission gate, and [1533] tool execution confirmation node.

FIG. 5 Is a diagram illustrating embedded service logic inside a sealed execution environment, where tool behaviors are monitored and logged for compliance verification. Elements include [1540] service execution core, [1541] behavior logging module, [1542] compliance verification processor, and [1543] audit relay hub.

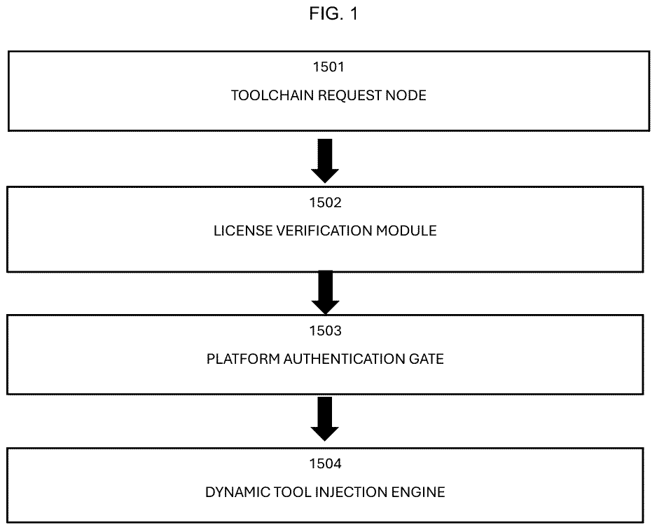

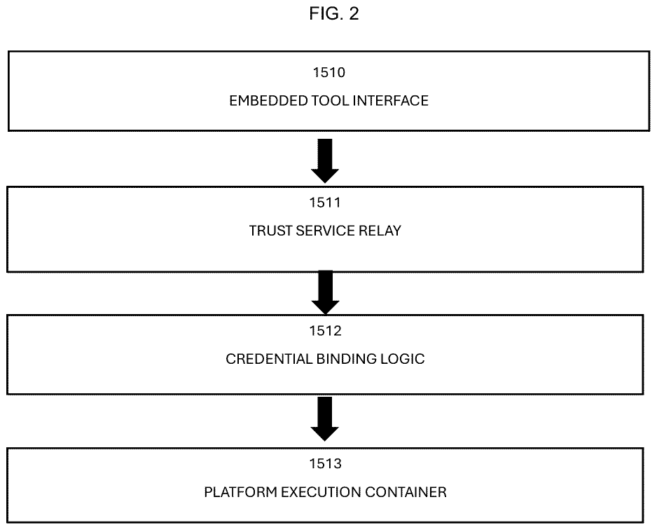

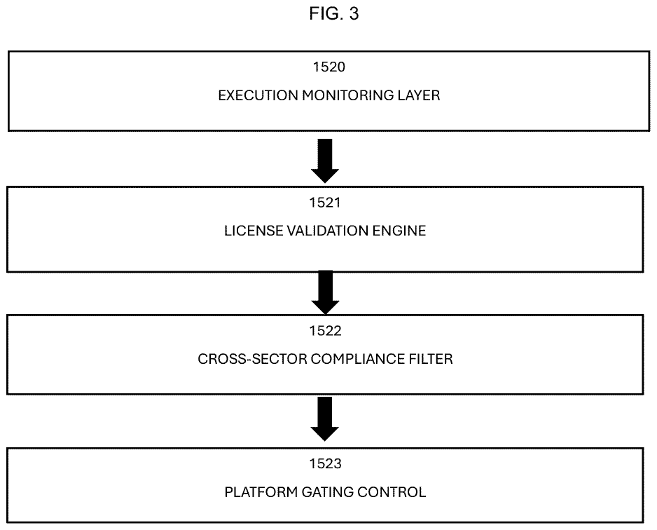

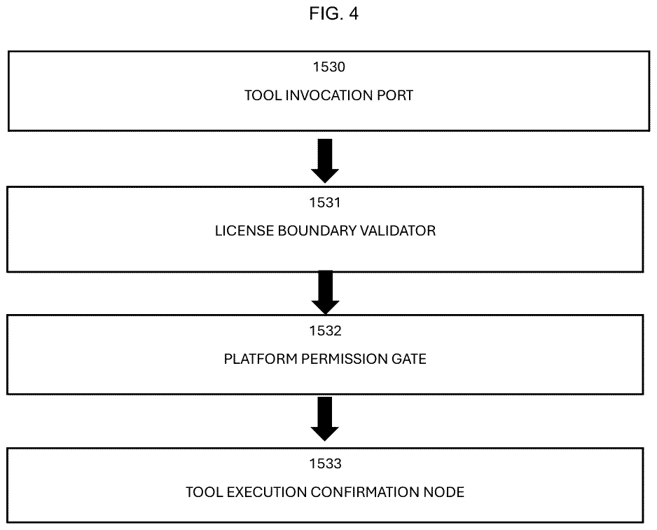

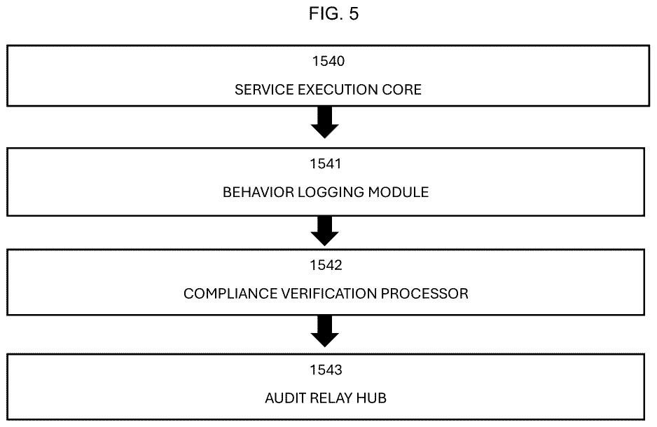

Each figure is uniquely identified by labels beginning at element 1501 and proceeding sequentially through element 1543, and each figure is distinct from those disclosed in FIGS. 1-12 of the master utility patent and FIG. 1-5 of continuation C5.

### DETAILED DESCRIPTION OF THE INVENTION

The system includes a compliance filtering engine embedded into the sealed execution rail.

Each offer attempt is first parsed for metadata including vendor license zone, jurisdictional match, tax ID, and platform classification.

A compliance matrix is then applied that checks:
Regulatory legality by region
Vendor license zone vs. offer zone
Trust score minimums
Tax ID validation
Platform-type permission (e.g., medical, legal, financial restrictions)

If all checks pass, the offer proceeds to escrow gating or sealed execution routing.

If any check fails, the offer is rejected with system-generated enforcement logs.

Compliance violations trigger penalties, trust decay, and vendor lockout.

The filtering engine dynamically updates based on new regulations, zone policies, and platform trust inputs.

Buyers are notified if offer rejection is due to compliance conflict, but no vendor metadata is disclosed.

The system ensures that only legal, platform-compliant, and jurisdictionally authorized transactions can proceed.

What is claimed is:

1. A compliance filtering system comprising:
a jurisdictional validation engine;
a regulatory compliance matrix;
and a platform rule enforcement layer, integrated into a sealed execution rail.

2. The system of claim 1, wherein the jurisdictional validation engine compares vendor license zones with target fulfillment regions.

3. The system of claim 1, wherein the regulatory compliance matrix includes tax policy validation and regional legality enforcement.

4. The system of claim 1, wherein offers are denied if platform-specific rules (e.g., medical regulation, legal restrictions) are not met.

5. A method comprising:
receiving a fulfillment attempt;
validating jurisdictional metadata;
applying regulatory filters;
and blocking execution upon violation.

6. The method of claim 5, wherein violations trigger enforcement logging and vendor suspension.

7. The system of claim 1, further comprising a trust-score threshold required for compliance clearance.

8. A compliance update system comprising:
regulatory change detection;
jurisdictional matrix updates;
and dynamic application to pending and future transactions.

9. The system of claim 1, wherein metadata includes license zones, vendor classification, region-specific permissions, and trust tier.

10. The method of claim 5, wherein offer presentation is denied if zone mismatch is detected.

11. A platform-governed compliance rail comprising:
vendor registration, jurisdictional alignment, and real-time regulatory filtering.

12. The system of claim 1, wherein rejected transactions are flagged for compliance audit.

13. A dynamic compliance enforcement engine comprising:
fulfillment rejection logs, vendor penalty tracking, and platform-issued warnings.

14. A method comprising:
pre-registering vendors by zone;
mapping compliance categories;
and enforcing permission boundaries before execution.

15. The system of claim 1, wherein compliance failure triggers trust-score decay and escrow lock.

16. The system of claim 1, wherein buyers are notified of rejection without disclosing vendor compliance metadata.

17. A multi-tier compliance rail comprising:
jurisdiction validation, regulatory scanning, and trust-layer filtering before execution.

18. The method of claim 5, wherein fulfillment is routed through platform-specific filters per commercial category.

19. The system of claim 1, wherein compliance failure blocks offer routing at both frontend and backend levels.

20. A sealed fulfillment engine integrating compliance filters, escrow triggers, vendor flags, and trust-score enforcement logic.

21. The system of claim 14, wherein the trust-verified delivery trigger comprises a geofenced validation node that restricts execution until a transport actor is physically located within a specified radius of the fulfillment origin.

22. The system of claim 15, wherein the route generation logic further includes a sealed token that must be verified at a mid-route checkpoint to maintain escrow activation.

23. The system of claim 16, wherein the delivery authorization is revoked if transport identity verification fails at any system-registered node during transit.

24. The system of claim 17, wherein the system reverts to a pending escrow state if no real-time confirmation is received within a pre-established delivery event window.
